(19) United States
(12) Patent Application Publication
(10) Pub. No.: US 2022/0404307 A1
(43) Pub. Date: Dec. 22, 2022

(54) WATER PH DETECTION SENSOR AND USE OF RUTHENIUM-IRIDIUM ELECTRODE AS PH SENSING MATERIAL

(71) Applicant: SHENZHEN ANGEL DRINKING WATER INDUSTRIAL GROUP CORPORATION, Shenzhen, Guangdong (CN)

(72) Inventors: Guoping LI, Shenzhen (CN); Kai ZHAO, Shenzhen (CN); Heng ZHANG, Shenzhen (CN); Siqi HUANG, Shenzhen (CN)

(73) Assignee: SHENZHEN ANGEL DRINKING WATER INDUSTRIAL GROUP CORPORATION, Shenzhen, Guangdong (CN)

(21) Appl. No.: 17/777,400

(22) PCT Filed: Apr. 13, 2021
(86) PCT No.: PCT/CN2021/086936

§ 371 Date: May 17, 2022

(30) Foreign Application Priority Data
Apr. 30, 2020 (CN) 202010365319.X

(51) Int. Cl. G01N 27/30

(52) U.S. Cl. CPC G01N 27/302; G01N 27/301

(57) ABSTRACT

A water pH detection sensor and a use of a ruthenium-iridium electrode as a PH sensing material. The water pH detection sensor includes a ruthenium-iridium electrode and a reference electrode, and the pH value of a solution to be detected is obtained by means of a voltage between the ruthenium-iridium electrode and the reference electrode. The ruthenium-iridium electrode is used as the pH sensing material, the electrode potential of the material in a solution has a good linear correspondingly relationship with a hydrogen ion concentration, and the material has the features of a wide pH value response range, a high response speed, a stable response performance and repeated measurement and use, and is suitable for different practical application scenarios.

### TECHNICAL FIELD

The invention belongs to the technical field of pH detection, and particularly relates to a water pH detection sensor and a use of a ruthenium-iridium electrode as a pH sensing material.

### BACKGROUND

The pH value reflects the hydrogen ion concentration in a water solution system and is an important physical and chemical parameter to be measured in actual life. The pH sensor, as a pH measurement device widely used at present, can easily, rapidly and accurately measure the pH value of samples in terms of a corresponding relationship between the electrode potential of a sensing electrode and pH. In addition, the pH sensor has the features of being high in measurement accuracy, good in stability, wide in application range and portable.

Glass electrodes are used by most pH meters on the present market as measurement electrodes because of their mature technology and good measurement performance. However, the glass electrodes have the problems of being made of a fragile material, having high requirements for the manufacturing process, and needing to be preserved and soaked in a water solution.

### SUMMARY

In view of the defects of the prior art, the invention provides a novel water pH detection sensor using a ruthenium-iridium electrode as a PH sensing material.

The invention provides a water pH detection sensor, comprising a ruthenium-iridium electrode and a reference electrode, wherein the pH value of a solution to be detected is obtained by means of a voltage between the ruthenium-iridium electrode and the reference electrode.

In some embodiments of the invention, the ruthenium-iridium electrode is obtained by thermal decomposition of a ruthenium oxide-iridium oxide titanium-based material.

In some embodiments of the invention, the ruthenium-iridium electrode is prepared by:

Dissolving ruthenium trichloride and chloro-iridic acid in absolute ethyl alcohol to obtain a base coating solution, wherein in the base coating solution, a ratio of the molar concentration of the ruthenium trichloride to the molar concentration of the chloro-iridic acid is 1:3-2:3, and a total metal molar concentration is 40 mM-60 mM;

Evenly spreading the base coating solution on a titanium base, and obtaining the ruthenium oxide-iridium oxide titanium-based material after a solvent thereof is volatilize and dried; and

Carrying out thermal decomposition on the ruthenium oxide-iridium oxide titanium-based material to obtain the ruthenium-iridium electrode.

In some embodiments of the invention, the thermal decomposition is carried out at 350° C. -450° C. for 3 hrs-5 hrs.

In some embodiments of the invention, the reference electrode is an Ag/AgCl electrode or a tin-plated electrode.

In some embodiments of the invention, the pH value of the solution to be detected is obtained according to the following formula:

pH=−19.96E+11.99;

Wherein, E is the voltage between the ruthenium-iridium electrode and the reference electrode, and the unit of the voltage is V.

The invention further provides a use of a ruthenium-iridium electrode as a pH sensing material.

The ruthenium-iridium electrode is used as a pH sensing material. The electrode potential of the material in a solution has a good linear corresponding relationship with a hydrogen ion concentration. Compared with glass electrodes, the ruthenium-iridium electrode has the features of being stable in material, low in manufacturing cost and easy to store. The pH detection sensor of the invention has a wide pH value response range (pH=2-12), a high response speed, a stable response performance and repeated measurement and use, and is suitable for different practical application scenarios.

Additional aspects and advantages of the invention will be given in the following description, and part of these aspects and advantages will become obvious in the following description or be known in the practice of the invention.

### BRIEF DESCRIPTION OF THE DRAWINGS

FIG. 1 illustrates a schematic diagram of a water pH detection sensor according to one embodiment of the invention.

FIG. 2 illustrates the relationship between the response voltage of a sensor, composed of a ruthenium-iridium electrode and an Ag/AgCl electrode, and pH according to one embodiment of the invention.

FIG. 3 illustrates a chart of the response voltage of the sensor composed of the ruthenium-iridium electrode and the Ag/AgCl electrode when the sensor measures buffer solutions with pH being 2, 4, 6, 8, 10, 12, 10, 8, 6, 4 and 2 in turn according to one embodiment of the invention.

FIG. 4 illustrates a change chart of the response voltage of the sensor, composed of the ruthenium-iridium electrode and the Ag/AgCl electrode, in buffer solutions with pH being 2, 4, 6, 8, 10 and 12 within 15 min according to one embodiment of the invention.

FIG. 5 illustrates the relationship between the response voltage of a sensor, composed of a ruthenium-iridium electrode and a tin-plated electrode, and pH according to one embodiment of the invention.

### DETAILED DESCRIPTION OF THE EMBODIMENTS

To gain a better understanding of the solutions and advantages of the invention, specific implementations of the invention will be described in further detail below in conjunction with the accompanying drawings and embodiments. Obviously, the specific implementations and embodiments in the following description are merely for the purpose of description, and are not intended to limit the invention.

It should be noted that, unless otherwise expressly stated and defined, terms such as “mount”, “link” and “connect” in the description of the invention should be broadly understood. For example, “connect” may refer to fixed connection, detachable connection or integrated connection; or, mechanical connection or electrical connection; or, direct connection, or indirect connection through an intermediate medium, or internal communication of two elements. Those ordinarily skilled in the art may understand the specific meaning of these terms in the invention as the case may be.

In the prior art, ruthenium-iridium electrodes are always used in electrolysis units to electrolyze waste water. The inventors find that the ruthenium-iridium electrodes have an extremely good responsivity to pH values, and the electrode potential of the ruthenium-iridium electrodes in a solution has a good linear corresponding relationship with a hydrogen ion concentration of the solution.

The invention provides a water pH detection sensor, comprising a ruthenium-iridium electrode and a reference electrode. During detection, the ruthenium-iridium electrode and the reference electrode are inserted into a solution to be detected, and then a voltage between the ruthenium-iridium electrode and the reference electrode is measured, so that the pH value of the solution to be detected is obtained according to a relevant formula.

In the invention, the pH value of the solution to be detected is obtained according to the following formula.

pH=−19.96E+11.99;

Wherein, E is the voltage between the ruthenium-iridium electrode and the reference electrode, and the unit of the voltage is V.

In the invention, the reference electrode is an Ag/AgCl electrode (3M KCl), a tin-plated electrode, or an electrode material with a basically constant electrode potential under different pH conditions.

In the invention, the ruthenium-iridium electrode is obtained through thermal decomposition of a ruthenium oxide-iridium oxide titanium-based material. Optically, a preparation method of the ruthenium-iridium electrode comprises the following steps:

(1) Ruthenium trichloride and chloro-iridic acid are dissolved in absolute ethyl alcohol to obtain a base coating solution;

Wherein, in the base coating solution, a ratio of the molar concentration of the ruthenium trichloride to the molar concentration of the chloro-iridic acid is 1:3-2:3, and the total metal molar concentration is 40 mM-60 mM;

(2) The base coating solution is evenly spread on a titanium base, and the ruthenium oxide-iridium oxide titanium-based material is obtained after a solvent is volatilize and dried; and

(3) Thermal decomposition is carried out on the ruthenium oxide-iridium oxide titanium-based material to obtain the ruthenium-iridium electrode.

Coating and thermal decomposition may be repeated 4-8 times.

In the invention, the thermal decomposition is carried out at 350° C. −450° C. for 3 hrs-5 hrs. Preferably, the thermal decomposition is carried out at 400° C. for 4 hrs.

The invention will be explained below with reference to specific embodiments. The values of process conditions adopted in the following embodiments are illustrative, and the ranges of these values are given in the brief summary of the invention. Process parameters that are not specifically indicated may be set with reference to conventional techniques. All detection methods used in the following embodiments are common detection methods in this field.

### Embodiment 1

Ruthenium trichloride and chloro-iridic acid were dissolved in absolute ethyl alcohol to obtain a base coating solution, wherein a ratio of the molar concentration of the ruthenium trichloride to the molar concentration of the chloro-iridic acid was controlled to 1:2, and the total metal molar concentration was 50 mM. The base coating solution was evenly spread on a titanium base, and thermal decomposition was carried out at 400° C. for 4 hrs after a solvent was volatilized and dried. A ruthenium-iridium electrode was obtained after coating and thermal decomposition were repeated five times.

A simple sensor (samples 1-4) was manufactured by the obtained ruthenium-iridium electrode, an Ag/AgCl electrode (3M KCl) and a voltmeter. The pair of electrodes was placed in to-be-detected buffer solutions with pH being 2, 4, 6, 8, 10 and 12 respectively to measure the response voltage (as shown in FIG. 1).

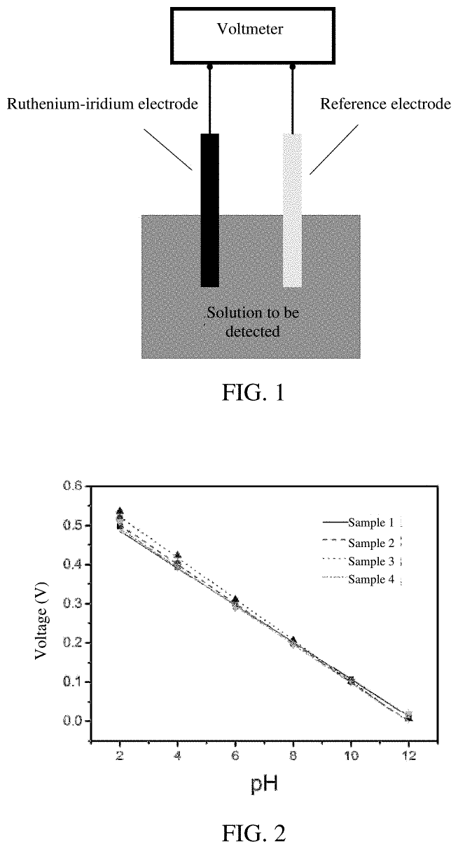

Specific test results are shown in FIG. 2 and Table 1.

The long-term measurement performance of the sensor (samples 1-4) was also tested. Voltage data of the to-be-detected buffer solutions with pH being 2-12 within 30 days was measured by the sensor. Specific test results are shown in Table 2-5.

### Embodiment 2

Ruthenium trichloride and chloro-iridic acid were dissolved in absolute ethyl alcohol to obtain a base coating solution, wherein a ratio of the molar concentration of the ruthenium trichloride to the molar concentration of the chloro-iridic acid was controlled to 1:2, and the total metal molar concentration was 50 mM. The base coating solution was evenly spread on a titanium base, and thermal decomposition was carried out at 400° C. for 4 hrs after a solvent was volatilized and dried. A ruthenium-iridium electrode is obtained after coating and thermal decomposition were repeated five times.

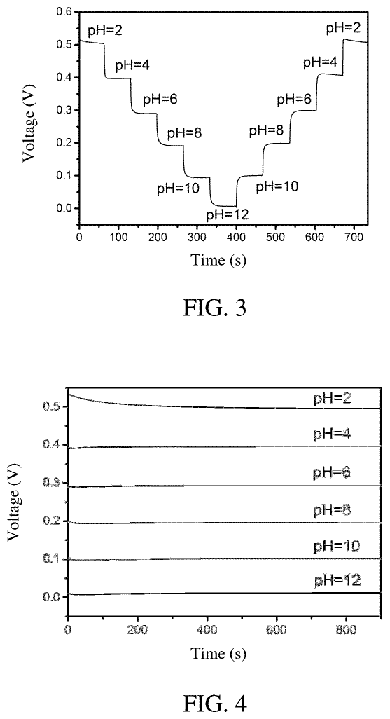

A simple sensor was manufactured by the obtained ruthenium-iridium electrode, an Ag/AgCl electrode (3M KCl) and a voltmeter. The sensor was used to measure the response voltage in buffer solutions with pH being 2, 4, 6, 8, 10, 12, 10, 8, 6, 4 and 2 in turn, and the measurement time of each pH solution was 1min Specific results are shown in FIG. 3.

The voltage reading stability of the sensor was also tested. The response voltage in the buffer solutions with pH being 2, 4, 6, 8, 10 and 12 within 15 min was measured by the sensor. Specific results are shown in FIG. 4.

### Embodiment 3

Ruthenium trichloride and chloro-iridic acid were dissolved in absolute ethyl alcohol to obtain a base coating solution, wherein a ratio of the molar concentration of the ruthenium trichloride to the molar concentration of the chloro-iridic acid was controlled to 1:2, and the total metal molar concentration was 50 mM. The base coating solution was evenly spread on a titanium base, and thermal decomposition was carried out at 400° C. for 4 hrs after a solvent was volatilized and dried. A ruthenium-iridium electrode was obtained after coating and thermal decomposition were repeated five times.

A simple sensor was manufactured by the obtained ruthenium-iridium electrode, an Ag/AgCl electrode (3M KCl) and a voltmeter. The sensor was used to measure different samples such as buffer solutions, tap water and cider vinegar, and measurement results were compared with measurement results obtained by a pH meter on the market (REX, PHS-3E). Specific results are shown in Table 6.

### Embodiment 4

Ruthenium trichloride and chloro-iridic acid were dissolved in absolute ethyl alcohol to obtain a base coating solution, wherein a ratio of the molar concentration of the ruthenium trichloride to the molar concentration of the chloro-iridic acid was controlled to 1:3, and the total metal molar concentration was 60 mM. The base coating solution was evenly spread on a titanium base, and thermal decomposition was carried out at 450° C. for 3 hrs after a solvent was volatilized and dried. A ruthenium-iridium electrode was obtained after coating and thermal decomposition were repeated four times.

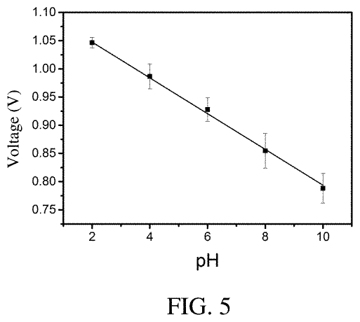

A simple sensor was manufactured by the obtained ruthenium-iridium electrode, a tin-plated electrode and a voltmeter. The pair of electrodes was placed in to-be-detected buffer solutions with pH being 2, 4, 6, 8 and 10 respectively to measure the response voltage (as shown in FIG. 1). Specific test results are shown in FIG. 5 and Table 7.

TABLE 1
Response voltage (V) of the pH sensor composed
of the ruthenium-iridium electrode and the Ag/AgCl
electrode under different pH conditions

| pH | Sample 1 | Sample 2 | Sample 3 | Sample 4 |
|---|---|---|---|---|
| 2 | 0.4980 | 0.5194 | 0.5352 | 0.5099 |
| 4 | 0.3940 | 0.4033 | 0.4234 | 0.3958 |
| 6 | 0.2933 | 0.2955 | 0.3107 | 0.2906 |
| 8 | 0.2004 | 0.1972 | 0.2066 | 0.1960 |
| 10 | 0.1062 | 0.0999 | 0.1016 | 0.1017 |
| 12 | 0.0178 | 0.0094 | 0.0058 | 0.0194 |

TABLE 2
Voltage (V) of sample 1 within 30 days

| Days | pH = 2 | pH = 4 | pH = 6 | pH = 8 | pH = 10 | pH = 12 |
|---|---|---|---|---|---|---|
| 1 | 0.4980 | 0.3940 | 0.2933 | 0.2004 | 0.1062 | 0.0178 |
| 6 | 0.5247 | 0.4194 | 0.3163 | 0.2215 | 0.1258 | 0.0402 |
| 9 | 0.5323 | 0.4263 | 0.3226 | 0.2265 | 0.1297 | 0.0383 |
| 16 | 0.5391 | 0.4331 | 0.3295 | 0.2325 | 0.1357 | 0.0536 |
| 23 | 0.5492 | 0.4429 | 0.3381 | 0.2408 | 0.1442 | 0.0628 |
| 30 | 0.4950 | 0.3894 | 0.2838 | 0.1864 | 0.0896 | 0.0127 |

TABLE 3
Voltage (V) of sample 2 within 30 days

| Days | pH = 2 | pH = 4 | pH = 6 | pH = 8 | pH = 10 | pH = 12 |
|---|---|---|---|---|---|---|
| 1 | 0.5194 | 0.4033 | 0.2955 | 0.1972 | 0.0999 | 0.0094 |
| 6 | 0.5370 | 0.4169 | 0.3080 | 0.2092 | 0.1126 | 0.0284 |
| 9 | 0.5418 | 0.4213 | 0.3125 | 0.2130 | 0.1151 | 0.0249 |
| 16 | 0.5526 | 0.4322 | 0.3233 | 0.2227 | 0.1255 | 0.0447 |
| 23 | 0.5661 | 0.4465 | 0.3366 | 0.2361 | 0.1380 | 0.0599 |
| 30 | 0.5644 | 0.4445 | 0.3355 | 0.2373 | 0.1404 | 0.0615 |

TABLE 4
Voltage (V) of sample 3 within 30 days

| Days | pH = 2 | pH = 4 | pH = 6 | pH = 8 | pH = 10 | pH = 12 |
|---|---|---|---|---|---|---|
| 1 | 0.5352 | 0.4234 | 0.3107 | 0.2066 | 0.1016 | 0.0058 |
| 6 | 0.5580 | 0.4453 | 0.3315 | 0.2260 | 0.1198 | 0.0268 |
| 9 | 0.5620 | 0.4494 | 0.3356 | 0.2289 | 0.1216 | 0.0222 |
| 16 | 0.5686 | 0.4556 | 0.3421 | 0.2351 | 0.1288 | 0.0393 |
| 23 | 0.5775 | 0.4647 | 0.3501 | 0.2435 | 0.1364 | 0.0472 |
| 30 | 0.5863 | 0.4730 | 0.3588 | 0.2521 | 0.1457 | 0.0583 |

TABLE 5
Voltage (V) of sample 4 within 30 days

| Days | pH = 2 | pH = 4 | pH = 6 | pH = 8 | pH = 10 | pH = 12 |
|---|---|---|---|---|---|---|
| 1 | 0.5099 | 0.3958 | 0.2906 | 0.1960 | 0.1017 | 0.0194 |
| 6 | 0.5297 | 0.4112 | 0.3041 | 0.2083 | 0.1131 | 0.0313 |
| 9 | 0.5355 | 0.4179 | 0.3118 | 0.2150 | 0.1190 | 0.0391 |
| 16 | 0.5433 | 0.4252 | 0.3178 | 0.2198 | 0.1237 | 0.0474 |
| 23 | 0.5289 | 0.4114 | 0.3014 | 0.2034 | 0.1070 | 0.0308 |
| 30 | 0.5308 | 0.4136 | 0.3056 | 0.2079 | 0.1130 | 0.0384 |

TABLE 6
Comparison of actual measurement results of
the sensor and the pH meter on the market

| Sample | Sensor | pH meter on the market |
|---|---|---|
| Potassium hydrogen phthalate | 4.19 | 4.06 |
| buffer solution | | |
| Mixed phosphate buffer | 7.16 | 6.86 |
| solution | | |
| Sodium tetraborate buffer | 8.75 | 9 |
| soltuion | | |
| Tap water | 7.64 | 7.05 |
| Cider vinegar | 3.37 | 3.31 |

TABLE 7
Respose voltage (V) of the pH sensor composed
of the ruthenium-iridium electrode and the tin-
plated electrode under different pH conditions

| pH | Response voltage |
|---|---|
| 2 | 1.0465 |
| 4 | 0.9868 |
| 6 | 0.9280 |
| 8 | 0.8548 |
| 10 | 0.7883 |

As can be seen from Table 1 and FIG. 2, the voltage of the sensor manufactured using the ruthenium-iridium electrode as a pH sensing material has a linear relationship with the pH value of the solution to be detected. The electrode potential of the ruthenium-iridium electrode in the solution has a good linear corresponding relationship with the hydrogen ion concentration, and has a wide pH value response range (pH=2-12).

As can be seen from FIG. 3, the sensor manufactured using the ruthenium-iridium electrode as the pH sensing material has a high response speed to pH changes, and measurement results are accurate and repeatable.

As can be seen from FIG. 4, the sensor manufactured using the ruthenium-iridium electrode as the pH sensing material has a stable voltage within 15 min. As can be seen from Table 2 to Table 5, the sensor manufactured using the ruthenium-iridium electrode as the pH sensing material has a stable response performance and a high repeatability and is able to operate reliably for a long time.

As can be seen from Table 6, the sensor manufactured using the ruthenium-iridium electrode as the pH sensing material has measurement results similar to those obtained by the pH meter on the market during actual measurement, thus having practical application value.

As can be seen Table 7 and FIG. 5, the measurement voltage of the pH sensor composed of the ruthenium-iridium electrode and the tin-plated electrode has a linear relationship with the pH of the solutions.

Obviously, the above embodiments are merely examples used to clearly explain the invention, and are not intended to limit the invention. Those ordinarily skilled in the art may make different variations or transformations based on the above description. It is unnecessary and impossible to enumerate all implementations of the invention. All these obvious variations or transformations obtained according to the above embodiments should also fall within the protection scope of the invention.

1-7. (canceled)

8. A water pH detection sensor, comprising: a ruthenium-iridium electrode and a reference electrode, wherein a pH value of a solution to be detected is obtained by a voltage between the ruthenium-iridium electrode and the reference electrode.

9. The sensor according to claim 8, wherein the ruthenium-iridium electrode is obtained by thermal decomposition of a ruthenium oxide-iridium oxide titanium-based material.

10. The sensor according to claim 9, wherein the ruthenium-iridium electrode is prepared by:
dissolving ruthenium trichloride and chloro-iridic acid in absolute ethyl alcohol to obtain a base coating solution, wherein in the base coating solution, a ratio of a molar concentration of the ruthenium trichloride to a molar concentration of the chloro-iridic acid is 1:3-2:3, and a total metal molar concentration is 40 mM-60 mM;
evenly spreading the base coating solution on a titanium base, and obtaining the ruthenium oxide-iridium oxide titanium-based material after a solvent thereof is volatilized and dried; and
carrying out thermal decomposition on the ruthenium oxide-iridium oxide titanium-based material to obtain the ruthenium-iridium electrode.

11. The sensor according to claim 10, wherein the thermal decomposition is carried out at 350° C.-450° C. for 3 hrs-5 hrs.

12. The sensor according to claim 8, wherein the reference electrode is an Ag/AgCl electrode or a tin-plated electrode.

13. The sensor according to claim 8, wherein the pH value of the solution to be detected is obtained according to the following formula:
pH=−19.96E+11.99;
wherein, E is the voltage between the ruthenium-iridium electrode and the reference electrode, and the unit of the voltage is V.

14. A use of a ruthenium-iridium electrode as a pH sensing material.
